(19) United States
(12) Patent Application Publication
(10) Pub. No.: US 2009/0088509 A1
(43) Pub. Date: Apr. 2, 2009

(54) COPOLYCARBONATE COMPOSITIONS

(75) Inventors: Purushotham Adoni, Bangalore (IN); Dibakar Dhara, Bangalore (IN); Vandita Pai-Paranjape, Evansville, IN (US); Ajay K. Taraiya, Bangalore (IN)

Correspondence Address: SABIC - LEXAN;SABIC Innovative Plastics - IP Legal, ONE PLASTICS AVE., PITTSFIELD, MA, 01201-3697, US

(73) Assignee: SABIC Innovative Plastics IP BV, Pittsfield, MA (US)

(21) Appl. No.: 11/863,447

(22) Filed: Sep. 28, 2007

(51) Int. Cl. C08K 3/32; C08G 77/448

(52) U.S. Cl. 524/417; 525/100

(57) ABSTRACT

A copolycarbonate composition is provided comprising a blend of a polycarbonate-polysiloxane copolymer and a terephthalate polymer. The blend has a combination of good melt volume rate, good fatigue resistance, and high ductility at low temperatures.

### BACKGROUND

The present disclosure relates to copolycarbonate compositions having a combination of high fatigue resistance and high melt volume rate. Also disclosed herein are methods for preparing and/or using the same.

Polycarbonates are synthetic thermoplastic resins derived from bisphenols and phosgenes, or their derivatives. They are linear polyesters of carbonic acid and can be formed from dihydroxy compounds and carbonate diesters, or by ester interchange. Polymerization may be in aqueous, interfacial, or in nonaqueous solution.

Polycarbonates are a very useful class of polymers. They have many properties and/or characteristics that are desired in certain instances. These properties include high impact strength, good heat resistance, weather and ozone resistance, good ductility, etc. Furthermore, polycarbonates can be readily used in various article formation processes, such as molding (injection molding, etc.), extrusion, and thermoforming, among others. As a result, polycarbonates are used frequently to form a wide variety of molded products such as: structural parts, tubes and piping, windows, lenses, automotive headlamps and components, medical devices, and household articles.

In particular, the LEXAN® EXL series of copolymers from GE Plastics, now known as SABIC Innovative Plastics, are polycarbonate-polydimethylsiloxane copolymers with good ductility at low temperatures, high flame retardance, high weatherability, and high processability, when compared to conventional polycarbonates. However, they have low fatigue resistance. High fatigue resistance is useful in certain applications, such as applications with hinges that are opened and closed frequently (for example, clamshell cell phones).

Higher fatigue resistance can generally be obtained by increasing the molecular weight of the polymer. However, increased molecular weight generally decreases the melt volume rate (MVR) of the polymer. For injection molding applications, this decrease in MVR limits production rates and the ability to make articles with thinner wall thickness.

It would be desirable to provide copolycarbonate compositions having a combination of good melt volume rate, high impact strength, and good ductility at low temperatures.

### BRIEF DESCRIPTION

Disclosed, in various embodiments, are copolycarbonate compositions and processes for making and using them. The copolycarbonate compositions have a combination of good fatigue resistance, high ductility at low temperatures, and good melt volume rate.

In embodiments, the copolycarbonate composition comprises a blend of a polycarbonate-polydimethylsiloxane (PC—Si) copolymer and a terephthalate polymer of Formula (IV):

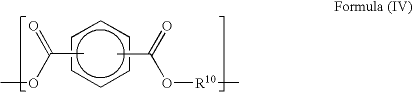

wherein R¹⁰ is a divalent aliphatic or cycloaliphatic radical containing from about 1 to about 10 carbon atoms; wherein the composition has a melt volume rate of at least 8 cc/10 min at 300° C./1.2 kg, according to ASTM D1238, and a notched Izod impact strength of at least 11.5 ft-lb/inch at minus 40° C., according to ASTM D256.

The terephthalate polymer may be selected from the group consisting of polyethylene terephthalate (PET), polybutylene terephthalate (PBT), and poly(1,4-cyclohexanedimethylene) terephthalate (PCT). In specific embodiments, it is PBT.

The copolycarbonate composition may comprise from about 5 wt % to about 20 wt % of the terephthalate polymer.

The composition may have a melt volume rate of at least 12 cc/10 min at 300° C./1.2 kg, according to ASTM D1238. The composition may also have a notched Izod impact strength of at least 12 ft-lb/in at minus 40° C., according to ASTM D256.

The PC—Si copolymer may be of the general Formula (III):

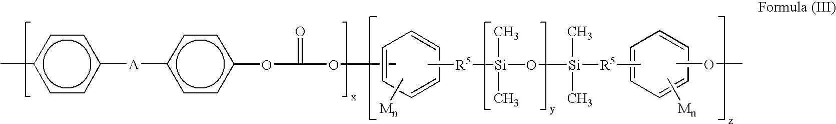

wherein A is selected from a bond, —O—, —S—, —SO₂—, C₁-C₁₂ alkyl, C₆-C₂₀ aromatic, and C₆-C₂₀ cycloaliphatic; each R⁵ is independently selected from divalent C₂-C₈ aliphatic; each M is independently selected from halogen, cyano, nitro, C₁-C₈ alkylthio, C₁-C₈ alkyl, C₁-C₈ alkoxy, C₂-C₈ alkenyl, C₂-C₈ alkenyloxy, C₃-C₈ cycloalkyl, C₃-C₈ cycloalkoxy, C₆-C₁₀ aryl, C₆-C₁₀ aryloxy, C₇-C₁₂ arylalkyl, C₇-C₁₂ arylalkoxy, C₇-C₁₂ alkylaryl, or C₇-C₁₂ alkylaryloxy; each n is independently an integer from 0 to 4; x is the mole percentage of the carbonate unit; y has an average value of from about 2 to about 1,000; and z is the mole percentage of the siloxane unit.

The ratio of x:z may be from about 20 to about 500. In further specific embodiments, the ratio of x:z may be from 50 to about 250.

The carbonate unit may be derived from bisphenol-A.

Articles may be molded from the copolycarbonate composition.

In further embodiments, the copolycarbonate is produced by blending a mixture of the PC—Si copolymer, the terephthalate polymer, and from about 40 ppm to about 60 ppm of phosphoric acid.

In other embodiments, a copolycarbonate composition comprises a blend of a polycarbonate-polydimethylsiloxane (PC—Si) copolymer and a terephthalate polymer;
wherein the PC—Si copolymer is of the general Formula (III):

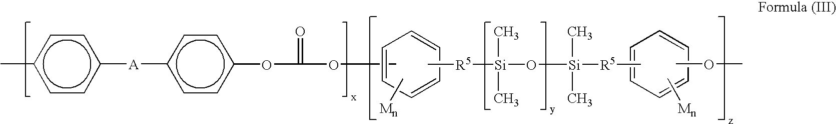

wherein A is isopropylidene; each R⁵ is independently selected from divalent C₂-C₈ aliphatic; each M is independently selected from halogen, cyano, nitro, C₁-C₈ alkylthio, C₁-C₈ alkyl, C₁-C₈ alkoxy, C₂-C₈ alkenyl, C₂-C₈ alkenyloxy, C₃-C₈ cycloalkyl, C₃-C₈ cycloalkoxy, C₆-C₁₀ aryl, C₆-C₁₀ aryloxy, C₇-C₁₂ arylalkyl, C₇-C₁₂ arylalkoxy, C₇-C₁₂ alkylaryl, or C₇-C₁₂ alkylaryloxy; each n is independently an integer from 0 to 4; x is the mole percentage of the carbonate unit; y has an average value of from about 2 to about 1,000; and z is the mole percentage of the siloxane unit;
wherein the terephthalate polymer is of the general Formula (IV):

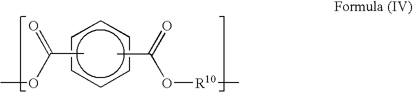

wherein R¹⁰ is a divalent aliphatic or cycloaliphatic radical containing from about 1 to about 10 carbon atoms;
wherein the terephthalate polymer comprises from about 5 to about 20 weight percent of the copolycarbonate composition; and
wherein the composition has a melt volume rate of at least 8 cc/10 min at 300° C./1.2 kg, according to ASTM D1238, and a notched Izod impact strength of at least 11.5 ft-lb/inch at minus 40° C., according to ASTM D256.

These and other non-limiting characteristics are more particularly described below.

### DETAILED DESCRIPTION

Numerical values in the specification and claims of this application, particularly as they relate to polymer compositions, reflect average values for a composition that may contain individual polymers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

The copolycarbonate compositions comprise a blend of a polycarbonate-polysiloxane (PC—Si) copolymer and a terephthalate polymer.

The PC—Si copolymer comprises a polycarbonate unit and a siloxane unit. As used herein, “polycarbonate” refers to an oligomer or polymer comprising residues of one or more dihydroxy compounds joined by carbonate linkages.

The polycarbonate unit may be a repeating structural carbonate unit of the formula (1):

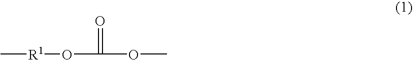

in which at least 60 percent of the total number of R¹ groups are aromatic organic radicals and the balance thereof are aliphatic, alicyclic, or aromatic radicals. In one embodiment, each R¹ is an aromatic organic radical, for example a radical of the formula (2):

-A¹-Y¹-A²- (2)

wherein each of A¹ and A² is a monocyclic divalent aryl radical and Y¹ is a bridging radical having one or two atoms that separate A¹ from A². In an exemplary embodiment, one atom separates A¹ from A². Illustrative non-limiting examples of radicals of this type are —O—, —S—, —S(O)—, —S(O)₂—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ may be a hydrocarbon group or a saturated hydrocarbon group such as methylene, cyclohexylidene, or isopropylidene.

Polycarbonates may be produced by the interfacial reaction of dihydroxy compounds having the formula HO—R¹—OH, which includes dihydroxy compounds of formula (3)

HO-A¹-Y¹-A²-OH (3)

wherein Y¹, A¹ and A² are as described above. Also included are bisphenol compounds of general formula (4):

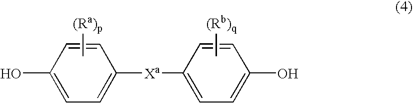

wherein R^{a} and R^{b} each represent a halogen atom or a monovalent hydrocarbon group and may be the same or different; p and q are each independently integers of 0 to 4; and X^{a} represents one of the groups of formula (5):

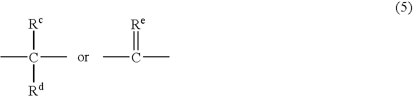

wherein R^{c} and R^{d} each independently represent a hydrogen atom or a monovalent linear or cyclic hydrocarbon group and R^{e} is a divalent hydrocarbon group.

In an embodiment, a heteroatom-containing cyclic alkylidene group comprises at least one heteroatom with a valency of 2 or greater, and at least two carbon atoms. Heteroatoms for use in the heteroatom-containing cyclic alkylidene group include —O—, —S—, and —N(Z)-, where Z is a substituent group selected from hydrogen, hydroxy, C₁₋₁₂ alkyl, C₁₋₁₂ alkoxy, or C₁₋₁₂ acyl. Where present, the cyclic alkylidene group or heteroatom-containing cyclic alkylidene group may have 3 to 20 atoms, and may be a single saturated or unsaturated ring, or fused polycyclic ring system wherein the fused rings are saturated, unsaturated, or aromatic.

Other bisphenols containing substituted or unsubstituted cyclohexane units can be used, for example bisphenols of formula (6):

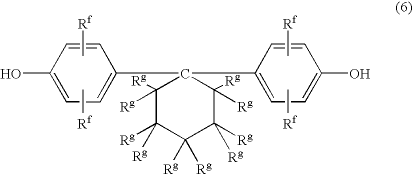

wherein each R^{f} is independently hydrogen, C₁₋₁₂ alkyl, or halogen; and each R⁹ is independently hydrogen or C₁₋₁₂ alkyl. The substituents may be aliphatic or aromatic, straight chain, cyclic, bicyclic, branched, saturated, or unsaturated. Such cyclohexane-containing bisphenols, for example the reaction product of two moles of a phenol with one mole of a hydrogenated isophorone, are useful for making polycarbonate polymers with high glass transition temperatures and high heat distortion temperatures.

The siloxane units of the PC—Si copolymer may generally have the repeating structure of formula (10):

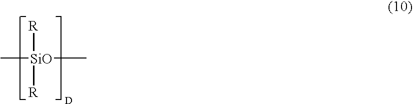

wherein each occurrence of R is same or different, and is a C₁₋₁₃ monovalent organic radical. For example, R may independently be a C₁-C₁₃ alkyl group, C₁-C₁₃ alkoxy group, C₂-C₁₃ alkenyl group, C₂-C₁₃ alkenyloxy group, C₃-C₆ cycloalkyl group, C₃-C₆ cycloalkoxy group, C₆-C₁₄ aryl group, C₆-C₁₀ aryloxy group, C₇-C₁₃ arylalkyl group, C₇-C₁₃ arylalkoxy group, C₇-C₁₃ alkylaryl group, or C₇-C₁₃ alkylaryloxy group. The foregoing groups may be fully or partially halogenated with fluorine, chlorine, bromine, or iodine, or a combination thereof. Combinations of the foregoing R groups may be used in the same copolymer.

The value of D in formula (10) may vary widely depending on the type and relative amount of each component in the polymer, the desired properties of the polymer, and like considerations. Generally, D may have an average value of 2 to 1,000, specifically 2 to 500, and more specifically 5 to 100. In one embodiment, D has an average value of 10 to 75, and in still another embodiment, D has an average value of 30 to 45. The phrase “average value” is used to indicate that various siloxane blocks of siloxane units in the PC—Si copolymer may have different lengths.

In some embodiments, the siloxane unit may be derived from structural units of formula (11):

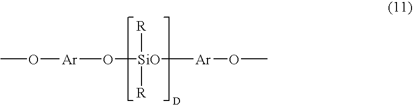

wherein D is as defined above; each R may independently be the same or different, and is as defined above; and each Ar may independently be the same or different, and is a substituted or unsubstituted C₆-C₃₀ arylene radical, wherein the bonds are directly connected to an aromatic moiety. Useful Ar groups in formula (11) may be derived from a C₆-C₃₀ dihydroxyarylene compound, for example a dihydroxyarylene compound of formula (3), (4), or (7) above. Combinations comprising at least one of the foregoing dihydroxyarylene compounds may also be used. Specific examples of dihydroxyarylene compounds are 1,1-bis(4-hydroxyphenyl)methane, 1,1-bis(4-hydroxyphenyl)ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl)cyclohexane, bis(4-hydroxyphenyl sulphide), and 1,1-bis(4-hydroxy-t-butylphenyl) propane. Combinations comprising at least one of the foregoing dihydroxy compounds may also be used.

Units of formula (11) may be derived from the corresponding dihydroxy compound of formula (12):

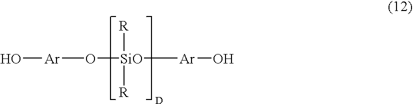

wherein R, Ar, and D are as described above. Compounds of formula (12) may be obtained by the reaction of a dihydroxyarylene compound with, for example, an alpha, omega-bisacetoxypolydiorganosiloxane under phase transfer conditions.

In other embodiments, the siloxane unit may be derived from structural units of formula (13):

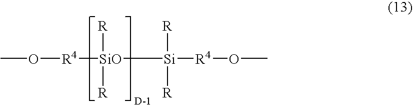

wherein R and D are as described above, and each occurrence of R⁴ is independently a divalent C₁-C₃₀ alkylene, and wherein the polymerized polysiloxane unit is the reaction residue of its corresponding dihydroxy compound.

In other embodiments, the siloxane unit may be derived from structural units of formula (14):

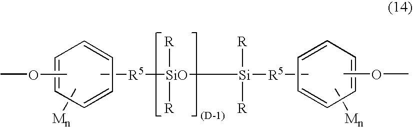

wherein R and D are as defined above. Each R⁵ in formula (14) is independently a divalent C₂-C₈ aliphatic group. Each M in formula (14) may be the same or different, and may be a halogen, cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ arylalkyl, C₇-C₁₂ arylalkoxy, C₇-C₁₂ alkylaryl, or C₇-C₁₂ alkylaryloxy, wherein each n is independently 0, 1, 2, 3, or 4.

In one embodiment, M is bromo or chloro, an alkyl group such as methyl, ethyl, or propyl, an alkoxy group such as methoxy, ethoxy, or propoxy, or an aryl group such as phenyl, chlorophenyl, or tolyl; R⁵ is a dimethylene, trimethylene or tetramethylene group; and R is a C₁₋₈ alkyl, haloalkyl such as trifluoropropyl, cyanoalkyl, or aryl such as phenyl, chlorophenyl or tolyl. In another embodiment, R is methyl, or a mixture of methyl and trifluoropropyl, or a mixture of methyl and phenyl. In still another embodiment, M is methoxy, n is one, R⁵ is a divalent C₁-C₃ aliphatic group, and R is methyl.

Units of formula (14) may be derived from the corresponding dihydroxy polydiorganosiloxane (15):

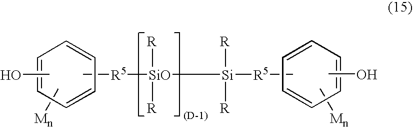

wherein R, D, M, R⁵, and n are as described above. Such dihydroxy polysiloxanes can be made by effecting a platinum catalyzed addition between a siloxane hydride of formula (16):

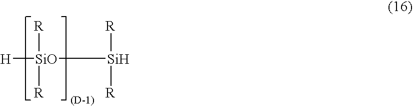

wherein R and D are as previously defined, and an aliphatically unsaturated monohydric phenol. Useful aliphatically unsaturated monohydric phenols included, for example, eugenol, 2-allylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. Mixtures comprising at least one of the foregoing may also be used.

The PC—Si copolymer may be made by processes such as interfacial polymerization and melt polymerization. Although the reaction conditions for interfacial polymerization may vary, an exemplary process generally involves dissolving or dispersing a dihydric phenol reactant in aqueous caustic soda or potash, adding the resulting mixture to a suitable water-immiscible solvent medium, and contacting the reactants with a carbonate precursor in the presence of a catalyst such as triethylamine or a phase transfer catalyst, under controlled pH conditions, e.g., about 8 to about 10. The most commonly used water immiscible solvents include methylene chloride, 1,2-dichloroethane, chlorobenzene, toluene, and the like.

Carbonate precursors include, for example, a carbonyl halide such as carbonyl bromide or carbonyl chloride, or a haloformate such as a bishaloformates of a dihydric phenol (e.g., the bischloroformates of bisphenol-A, hydroquinone, or the like) or a glycol (e.g., the bishaloformate of ethylene glycol, neopentyl glycol, polyethylene glycol, or the like). Combinations comprising at least one of the foregoing types of carbonate precursors may also be used. In an exemplary embodiment, an interfacial polymerization reaction to form carbonate linkages uses phosgene as a carbonate precursor, and is referred to as a phosgenation reaction.

Among the phase transfer catalysts that may be used are catalysts of the formula (R³)₄Q⁺X, wherein each R³ is the same or different, and is a C₁₋₁₀ alkyl group; Q is a nitrogen or phosphorus atom; and X is a halogen atom or a C₁₋₈ alkoxy group or C₆₋₁₈ aryloxy group. Useful phase transfer catalysts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈ aryloxy group. An effective amount of a phase transfer catalyst may be about 0.1% by weight to about 10% by weight based on the weight of bisphenol in the phosgenation mixture. In another embodiment an effective amount of phase transfer catalyst may be about 0.5% by weight to about 2% by weight based on the weight of bisphenol in the phosgenation mixture.

Branched polycarbonate blocks may be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. The branching agents may be added at a level of about 0.05% by weight to about 2.0% by weight. Mixtures comprising linear polycarbonates and branched polycarbonates may be used.

In specific embodiments, the carbonate unit of the PC—Si copolymer is derived from a dihydroxy compound having the structure of Formula (1):

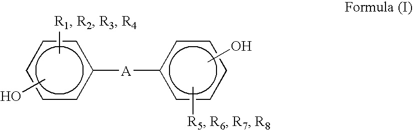

wherein R₁ through R₈ are each independently selected from hydrogen, halogen, nitro, cyano, C₁-C₂₀ alkyl, C₄-C₂₀ cycloalkyl, and C₆-C₂₀ aryl; and A is selected from a bond, —O—, —S—, —SO₂—, C₁-C₁₂ alkyl, C₆-C₂₀ aromatic, and C₆-C₂₀ cycloaliphatic.

In specific embodiments, the dihydroxy compound of Formula (1) is 2,2-bis(4-hydroxyphenyl) propane (i.e. bisphenol-A or BPA). Other illustrative compounds of Formula (I) include:
2,2-bis(3-bromo-4-hydroxyphenyl)propane;
2,2-bis(4-hydroxy-3-methylphenyl)propane;
2,2-bis(4-hydroxy-3-isopropylphenyl)propane;
2,2-bis(3-t-butyl-4-hydroxyphenyl)propane;
2,2-bis(3-phenyl-4-hydroxyphenyl)propane;
2,2-bis(3,5-dichloro-4-hydroxyphenyl)propane;
1,1-bis(4-hydroxyphenyl)cyclohexane;
1,1-bis(3-chloro-4-hydroxyphenyl)-3,3,5-trimethylcyclohexane;
4,4′dihydroxy-1,1-biphenyl;
4,4′-dihydroxy-3,3′-dimethyl-1,1-biphenyl;
4,4′-dihydroxy-3,3′-dioctyl-1,1-biphenyl;
4,4′-dihydroxydiphenylether;
4,4′-dihydroxydiphenylthioether; and
1,3-bis(2-(4-hydroxyphenyl)-2-propyl)benzene.

In specific embodiments, the siloxane unit of the PC—Si copolymer is derived from a dihydroxy compound having the structure of Formula (II):

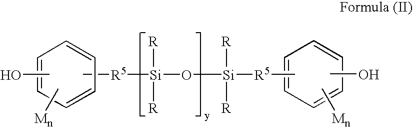

wherein each R is independently selected from C₁-C₁₃ alkyl, C₁-C₁₃ alkoxy, C₂-C₁₃ alkenyl, C₂-C₁₃ alkenyloxy, C₃-C₆ cycloalkyl, C₃-C₆ cycloalkoxy, C₆-C₁₄ aryl, C₆-C₁₀ aryloxy, C₇-C₁₃ arylalkyl, C₇-C₁₃ arylalkoxy, C₇-C₁₃ alkylaryl, or C₇-C₁₃ alkylaryloxy; each R⁵ is independently selected from divalent C₂-C₈ aliphatic; each M is independently selected from halogen, cyano, nitro, C₁-C₈ alkylthio, C₁-C₈ alkyl, C₁-C₈ alkoxy, C₂-C₈ alkenyl, C₂-C₈ alkenyloxy, C₃-C₈ cycloalkyl, C₃-C₈ cycloalkoxy, C₆-C₁₀ aryl, C₆-C₁₀ aryloxy, C₇-C₁₂ arylalkyl, C₇-C₁₂ arylalkoxy, C₇-C₁₂ alkylaryl, or C₇-C₁₂ alkylaryloxy; each n is independently an integer from 0 to 4; and y has an average value of from about 2 to about 1,000.

In specific embodiments, the R groups are the same and the R⁵ groups are the same. The numeral y may more specifically have an average value of from about 2 to about 500, and more specifically from about 5 to about 100. In one embodiment, y has an average value of from about 10 to about 75, and in still another embodiment, y has an average value of from about 30 to about 45.

In specific embodiments, the PC—Si copolymer is of the general Formula (III):

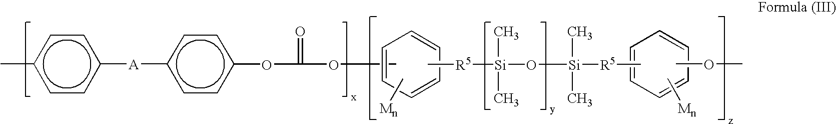

wherein A is selected from a bond, —O—, —S—, —SO₂—, C₁-C₁₂ alkyl, C₆-C₂₀ aromatic, and C₆-C₂₀ cycloaliphatic; each R⁵ is independently selected from divalent C₂-C₈ aliphatic; each M is independently selected from halogen, cyano, nitro, C₁-C₈ alkylthio, C₁-C₈ alkyl, C₁-C₈ alkoxy, C₂-C₈ alkenyl, C₂-C₈ alkenyloxy, C₃-C₈ cycloalkyl, C₃-C₈ cycloalkoxy, C₆-C₁₀ aryl, C₆-C₁₀ aryloxy, C₇-C₁₂ arylalkyl, C₇-C₁₂ arylalkoxy, C₇-C₁₂ alkylaryl, or C₇-C₁₂ alkylaryloxy; each n is independently an integer from 0 to 4; x is the mole percentage of the carbonate unit; y has an average value of from about 2 to about 1,000; and z is the mole percentage of the siloxane unit. Formula (III) shows only the two units and their molar percentages; it should not be construed as showing specific linkages within the PC—Si copolymer.

In specific embodiments, the ratio of x:z is from about 20 to about 500. As the ratio of x:z increases, the transparency of the composition increases (i.e. becomes more transparent). The compositions of the present disclosure are opaque. In addition, the temperature at which the ductile-to-brittle transition occurs increases as the ratio of x:z increases.

The copolycarbonate composition further comprises a terephthalate polymer of the following general Formula (IV):

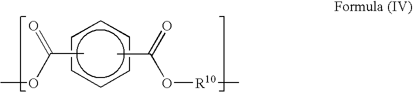

wherein R¹⁰ is a divalent aliphatic or cycloaliphatic radical containing from about 1 to about 10 carbon atoms. Exemplary terephthalates include polybutylene terephthalate (R¹⁰ is n-butyl), polyethylene terephthalate (R¹⁰ is n-ethyl), and poly(1,4-cyclohexanedimethylene) terephthalate. In specific embodiments, the terephthalate polymer is polybutylene terephthalate (PBT). The terephthalate polymer should be a semicrystalline polymer.

In embodiments, the terephthalate polymer has a weight average molecular weight (Mw) in the range of from about 50,000 to about 110,000.

The PC—Si copolymer is blended together with the terephthalate polymer, using well-known methods, to form a copolycarbonate composition. For example, they may be combined by mixing in solution or in melt in an extruder or other mixer. In embodiments, the terephthalate polymer comprises from about 5 weight percent to about 20 weight percent of the copolycarbonate composition.

During the blending of PC—Si copolymer and terephthalate polymer, transesterification reactions occur between the PC—Si copolymer and the terephthalate polymer. Phosphoric acid can be added to the mixture to quench the transesterification reaction. This helps the stability of the blend. From about 40 ppm to about 60 ppm of phosphoric acid, particularly about 50 ppm, is useful for quenching.

The copolycarbonate composition may further include other additives which can be incorporated with polymeric compositions, with the proviso that the additives are selected so as not to adversely affect the desired properties of the copolycarbonate composition. Mixtures of additives may be used. Such additives may be mixed at a suitable time during the mixing of the components for forming the thermoplastic composition. Examples of such additives include fillers, antioxidants, heat stabilizers, light stabilizers, plasticizers, mold release agents, lubricants, antistatic agents, flame retardants, and anti-drip agents.

The blend of PC—Si copolymer with terephthalate polymer has a desirable combination of properties. It has good fatigue resistance, retains ductility at low temperatures, and has good melt volume rate (MVR). This combination of properties is useful for thin wall molded articles that need good fatigue resistance, such as cellphone casings.

In embodiments, the copolycarbonate composition has a melt volume rate of at least 8 cc/10 min at 300° C./1.2 kg, according to ASTM D1238, and a notched Izod impact strength of at least 11.5 ft-lb/inch at minus 40° C., according to ASTM D256. In more specific embodiments, the copolycarbonate composition has a melt volume rate of at least 10 cc/min or at least 12 cc/10 min at 300° C./1.2 kg, according to ASTM D1238. In other specific embodiments, the copolycarbonate composition has a notched Izod impact strength of at least 12 ft-lb/inch at minus 40° C., according to ASTM D256. In further embodiments, the composition has a melt volume rate of at least 12 cc/10 min at 300° C./1.2 kg, according to ASTM D1238, and a notched Izod impact strength of at least 12 ft-lb/in at minus 40° C., according to ASTM D256.

A copolycarbonate composition with the combination of good fatigue resistance, high ductility at low temperatures, and good melt volume rate was unexpected. In addition, this combination had no problem with delamination. No polymeric resins were known to achieve this combination of properties when blended with PC—Si copolymer. For example, blending PC—Si copolymer with ULTEM®, a polyetherimide, improved the fatigue resistance, but dramatically lowered the MVR. Similarly, a blend of PC—Si copolymer with a styrene-acrylonitrile (SAN) copolymer had good fatigue resistance and good MVR, but poor ductility at low temperatures and problems with delamination.

The following examples are provided to illustrate the compositions and methods of the present disclosure. The examples are merely illustrative and are not intended to limit devices made in accordance with the disclosure to the materials, conditions, or process parameters set forth therein.

### EXAMPLES

Several compositions were made and tested. Mechanical properties were measured according to the following ASTM standards:

| | Standards | Testing Conditions |
|---|---|---|
| Melt Volume Rate | ASTM D 1238 | 300° C., 1.2 Kg |
| Tensile Modulus | ASTM D 638 | 50 mm/min |
| Notched Izod Impact | ASTM D 256 | −40 and −50° C. |

The compositions were fatigue tested according to the following test protocol. The test was performed in an environment of 23±2° C., 50±5% relative humidity. Test bars were conditioned in that environment for 48 hours prior to commencement of the test. Standard tensile test bars specified by ASTM D638, Type-I, were used. The test bar was clamped in a universal testing machine (MTS 858 or Instron 8874) and subjected to a sinusoidally varying load (between 100% and 10% of nominal stress level) at a specified frequency. The number of cycles to failure at a load of 28 MPa and a frequency of 5 Hz was reported. Results from at least two bars were taken, averaged, and reported.

PC—Si is a polycarbonate-polysiloxane copolymer with an absolute Mw of about 28,000 to 32,000 g/mol and a dimethylsiloxane content of about 20 weight percent (wt %). PC-1 is a BPA polycarbonate resin having an MVR of 5-7 cc/10 min at 300° C./1.2 kg and a Mw of 30,000 to 32,000. PC-2 is a BPA polycarbonate resin having an MVR of 21.9-31.8 cc/10 min at 300° C./1.2 kg and a Mw of 20,000 to 25,000. PBT is a PBT having a Mw of 100,000 to 110,000. All Mw's are reported based on polystyrene standards.

### Example 1

One control composition C1 and six test compositions E1-E6 were formulated. Control composition C1 contained no terephthalate or phosphoric acid. Test compositions E1-E3 did not use phosphoric acid, whereas E4-E6 were made using 50 ppm phosphoric acid to quench transesterification reactions. E3 used 30 wt % PBT, while the remaining test compositions used only 10 wt % PBT. They were then tested for MVR, fatigue, and impact strength. The notched Izod impact (NII) was tested at room temperature, minus 30° C., and minus 40° C. The compositions and results are shown in Table 1.

TABLE 1

| Description | Unit | C1 | E1 | E2 | E3 | E4 | E5 | E6 |
|---|---|---|---|---|---|---|---|---|
| PC-Si | wt % | 22.5 | 22.5 | 22.5 | 22.5 | 22.5 | 22.5 | 22.5 |
| PC-1 | wt % | 12.5 | 33.7 | 45 | 23.7 | 33.7 | 33.7 | 47.5 |
| PC-2 | wt % | 65 | 33.8 | 22.5 | 23.8 | 33.8 | 33.8 | 20 |
| PBT | wt % | 0 | 10 | 10 | 30 | 10 | 10 | 10 |
| Phosphoric Acid | ppm | 0 | 0 | 0 | 0 | 50 | 50 | 50 |
| Phosphite | wt % | 0.06 | 0.06 | 0.06 | 0.06 | 0.06 | 0.06 | 0.06 |
| MVR | cc/10 min | 12.4 | 13.6 | 12.3 | 22.4 | 12.2 | 12.2 | 12.3 |
| Fatigue @ 28.2 MPa | cycles | 18854 | 78895 | 72495 | 243082 | 56022 | 55656 | 71663 |
| NII @ 25° C. | ft-lb/in | 14 | 16.1 | 17.2 | 13.8 | 16.1 | 16 | 16.8 |
| NII @ −30° C. | ft-lb/in | 11.2 | 13.6 | 14.7 | 2.6 | 13.6 | 13.9 | 13.8 |
| NII @ −40° C. | ft-lb/in | 11.1 | 12.3 | 13.4 | 2.4 | 12.9 | 12.6 | 12.6 |
| Tg | ° C. | 147 | 135.8 | 137.5 | 128.5 | 135.6 | 138.6 | 122 |

The results showed that fatigue resistance increased when the composition had a combination of PC—Si and PBT compared to the compositions with only the PC—Si. The MVR of the test compositions were matched to allow the fatigue results to be compared. In E3, which had the greatest amount of PBT, the MVR increased dramatically but the NII also decreased dramatically. The compositions using 50 ppm phosphoric acid (E4-E6) also decreased in fatigue resistance compared to those that did not (E1-E3).

### Example 2

One control composition C7 and six test compositions E7-E12 were formulated to compare different polyesters and crystalline polymers. The PBT used was a PBT of Mw=100,000-110,000. PET-1 was a PET of Mw=70,000-80,000. PET-2 was a PET of Mw=50,000-60,000. PCT was poly(1,4-cyclohexanedimethylene) terephthalate of Mw=50,000-60,000. PP was a polypropylene. Nylon6 was a nylon. The results are shown in Table 2.

TABLE 2

| Description | Unit | C7 | E7 | E8 | E9 | E10 | E11 | E12 |
|---|---|---|---|---|---|---|---|---|
| PC-Si | wt % | 22.5 | 22.5 | 22.5 | 22.5 | 22.5 | 22.5 | 22.5 |
| PC-1 | wt % | 38.7 | 60 | 47.5 | 47.5 | 47.5 | 33.7 | 33.7 |
| PC-2 | wt % | 38.8 | 7.5 | 20 | 20 | 20 | 33.8 | 33.8 |
| Polymer Name | | | PBT | PET-1 | PET-2 | PCT | PP | Nylon6 |
| Polymer Amt | wt % | 0 | 10 | 10 | 10 | 10 | 10 | 10 |
| Phosphoric Acid | ppm | 0 | 50 | 50 | 50 | 50 | 0 | 0 |
| Phosphite | wt % | 0.06 | 0.06 | 0.06 | 0.06 | 0.06 | 0 | 0 |
| MVR | cc/10 min | 8.3 | 8.8 | 8.3 | 8.4 | 8.3 | 9.2 | 10.4 |
| Fatigue @ 28.2 MPa | cycles | 35571 | 71013 | 64657 | 50190 | 61206 | 10716 | 28082 |
| NII @ 25° C. | ft-lb/in | 13.8 | 17.2 | 15.4 | 15.2 | 16.4 | 9.5 | 15.3 |
| NII @ −30° C. | ft-lb/in | 11.9 | 14.6 | 13.2 | 12.8 | 14.0 | 7.9 | 13.1 |
| NII @ −40° C. | ft-lb/in | 11.4 | 13.5 | 11.9 | 12.5 | 12.6 | 7.5 | 12.6 |
| Tg | ° C. | 149.5 | 136.4 | 148.8 | 146.5 | 137 | NA | NA |

Compared to control C7, the non-polyesters E11 and E12 showed a decrease in fatigue resistance. However, the polyesters E7-E10 all showed an increase in fatigue resistance and NII at low temperatures while maintaining an acceptable MVR level.

### Example 3

Five control compositions C13-C17 and five test compositions E13-E17 were formulated to test the effect of varying PC—Si copolymer on compositions with and without PBT. Results are shown in Table 3.

TABLE 3

| Description | Unit | C13 | C14 | C15 | C16 | C17 |
|---|---|---|---|---|---|---|
| PC-Si | wt % | 5 | 10 | 15 | 20 | 25 |
| PC-1 | wt % | 55 | 50 | 45 | 40 | 35 |
| PC-2 | wt % | 40 | 40 | 40 | 40 | 40 |
| PBT | wt % | 0 | 0 | 0 | 0 | 0 |
| Phosphoric Acid | ppm | 0 | 0 | 0 | 0 | 0 |
| Phosphite | wt % | 0.06 | 0.06 | 0.06 | 0.06 | 0.06 |
| MVR | cc/10 min | 10.0 | 9.1 | 8.8 | 9.0 | 8.0 |
| Fatigue @ 28.2 MPa | cycles | 56557 | 49179 | 62706 | 45868 | 49310 |
| Description | Unit | E13 | E14 | E15 | E16 | E17 |
| PC-Si | wt % | 5 | 10 | 15 | 20 | 25 |
| PC-1 | wt % | 75 | 70 | 65 | 60 | 55 |
| PC-2 | wt % | 10 | 10 | 10 | 10 | 10 |
| PBT | wt % | 10 | 10 | 10 | 10 | 10 |
| Phosphoric Acid | ppm | 50 | 50 | 50 | 50 | 50 |
| Phosphite | wt % | 0.06 | 0.06 | 0.06 | 0.06 | 0.06 |
| MVR | cc/10 min | 12.6 | 10.8 | 9.8 | 9.4 | 9.1 |
| Fatigue @ 28.2 MPa | cycles | 78131 | 78482 | 77469 | 103618 | 80010 |

As the PC—Si content increased, the MVR and the fatigue resistance decreased in the control and test compositions. However, the MVR and fatigue resistance values were greater for the test compositions, which contained the terephthalate, than for the control samples, which had only PC—Si and polycarbonate.

### Example 4

A control composition C18 and three comparison compositions C19-C21 were formulated to test the effect of ULTEM®, a polyetherimide. Ultem 1010 is from SABIC Innovative Plastics (formerly GE Plastics) and is a polyetherimide made by reaction of bisphenol A dianhydride with about an equal molar amount of m-phenylene diamine having a weight average molecular weight (Mw) of about 33,000 g/mole. Results are shown in Table 4.

TABLE 4

| Description | Unit | C18 | C19 | C20 | C21 |
|---|---|---|---|---|---|
| PC-Si | wt % | 22.5 | 22.5 | 22.5 | 22.5 |
| PC-1 | wt % | 77.5 | 67.5 | 57.5 | 47.5 |
| UItem | wt % | 0 | 10 | 20 | 30 |
| Phosphite | wt % | | 0.06 | 0.06 | 0.06 |
| MVR | cc/10 min | 4.7 | 3.7 | 2.9 | 2.2 |
| Fatigue @ | cycles | 85281 | 94425 | 172686 | 227096 |
| 28.2 MPa | | | | | |

Table 4 shows that when the polyetherimide was added, the fatigue resistance increased, but the MVR dramatically decreased. In comparison, the test compositions of Tables 1-2 either maintained or increased their MVR along with increasing fatigue resistance.

The copolycarbonate compositions of the present disclosure have been described with reference to exemplary embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

1. A copolycarbonate composition, comprising a blend of a polycarbonate-polydimethylsiloxane (PC—Si) copolymer and a terephthalate polymer of Formula (IV): 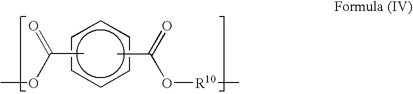
wherein R¹⁰ is a divalent aliphatic or cycloaliphatic radical containing from about 1 to about 10 carbon atoms;
wherein the composition has a melt volume rate of at least 8 cc/10 min at 300° C./1.2 kg, according to ASTM D1238, and a notched Izod impact strength of at least 11.5 ft-lb/inch at minus 40° C., according to ASTM D256.

2. The composition of claim 1, wherein the terephthalate polymer is selected from the group consisting of polyethylene terephthalate (PET), polybutylene terephthalate (PBT), and poly(1,4-cyclohexanedimethylene) terephthalate (PCT).

3. The composition of claim 1, wherein the terephthalate polymer comprises from about 5 to about 20 weight percent of the copolycarbonate composition.

4. The composition of claim 1, wherein the composition has a melt volume rate of at least 12 cc/10 min at 300° C./1.2 kg, according to ASTM D1238.

5. The composition of claim 1, wherein the composition has a notched Izod impact strength of at least 12 ft-lb/in at minus 40° C., according to ASTM D256

6. The composition of claim 1, wherein the composition has a melt volume rate of at least 12 cc/10 min at 300° C./1.2 kg, according to ASTM D1238, and a notched Izod impact strength of at least 12 ft-lb/in at minus 40° C., according to ASTM D256.

7. The composition of claim 1, wherein the PC—Si copolymer is of the general Formula (III): 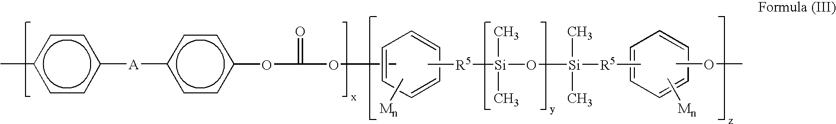
wherein A is selected from a bond, —O—, —S—, —SO₂—, C₁-C₁₂ alkyl, C₆-C₂₀ aromatic, and
C₆-C₂₀ cycloaliphatic; each R⁵ is independently selected from divalent C₂-C₈ aliphatic;
each M is independently selected from halogen, cyano, nitro, C₁-C₈ alkylthio, C₁-C₈ alkyl, C₁-C₈ alkoxy, C₂-C₈ alkenyl, C₂-C₈ alkenyloxy, C₃-C₈ cycloalkyl, C₃-C₈ cycloalkoxy, C₆-C₁₀ aryl, C₆-C₁₀ aryloxy, C₇-C₁₂ arylalkyl, C₇-C₁₂ arylalkoxy, C₇-C₁₂ alkylaryl, or C₇-C₁₂ alkylaryloxy; each n is independently an integer from 0 to 4; x is the mole percentage of the carbonate unit; y has an average value of from about 2 to about 1,000; and z is the mole percentage of the siloxane unit.

8. The composition of claim 7, wherein the ratio of x:z is from about 20 to about 500.

9. The composition of claim 7, wherein A is isopropylidene.

10. The composition of claim 1, wherein the terephthalate polymer has a weight average molecular weight of from about 50,000 to about 110,000.

11. An article molded from a copolycarbonate composition comprising a blend of a polycarbonate-polydimethylsiloxane (PC—Si) copolymer and a terephthalate polymer of Formula (IV): 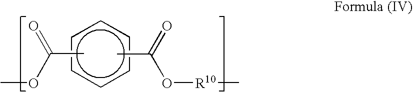
wherein R¹⁰ is a divalent aliphatic or cycloaliphatic radical containing from about 1 to about 10 carbon atoms;
wherein the composition has a melt volume rate of at least 8 cc/10 min at 300° C./1.2 kg, according to ASTM D1238, and a notched Izod impact strength of at least 11.5 ft-lb/inch at minus 40° C., according to ASTM D256.

12. A copolycarbonate composition, comprising a blend of a polycarbonate-polydimethylsiloxane (PC—Si) copolymer and a terephthalate polymer of Formula (IV): 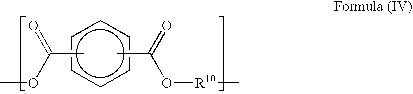
wherein R¹⁰ is a divalent aliphatic or cycloaliphatic radical containing from about 1 to about 10 carbon atoms;
wherein the composition has a melt volume rate of at least 8 cc/10 min at 300° C./1.2 kg, according to ASTM D1238, and a notched Izod impact strength of at least 11.5 ft-lb/inch at minus 40° C., according to ASTM D256; and
wherein the composition is produced by blending a mixture of the PC—Si copolymer, the terephthalate polymer, and from about 40 ppm to about 60 ppm of phosphoric acid.

13. The composition of claim 12, wherein the terephthalate polymer comprises from about 5 to about 20 weight percent of the copolycarbonate composition.

14. The composition of claim 12, wherein the composition has a melt volume rate of at least 12 cc/10 min at 300° C./1.2 kg, according to ASTM D1238.

15. The composition of claim 12, wherein the composition has a notched Izod impact strength of at least 12 ft-lb/in at minus 40° C., according to ASTM D256

16. The composition of claim 12, wherein the composition has a melt volume rate of at least 12 cc/10 min at 300° C./1.2 kg, according to ASTM D1238, and a notched Izod impact strength of at least 12 ft-lb/in at minus 40° C., according to ASTM D256.

17. The composition of claim 12, wherein the PC—Si copolymer is of the general Formula (III): 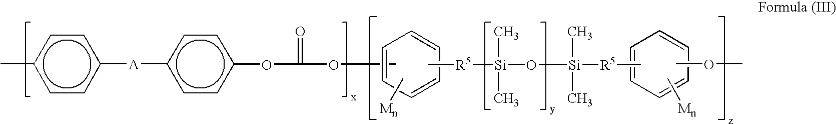
wherein A is selected from a bond, —O—, —S—, —SO₂—, C₁-C₁₂ alkyl, C₆-C₂₀ aromatic, and C₆-C₂₀ cycloaliphatic; each R⁵ is independently selected from divalent C₂-C₈ aliphatic; each M is independently selected from halogen, cyano, nitro, C₁-C₈ alkylthio, C₁-C₈ alkyl, C₁-C₈ alkoxy, C₂-C₈ alkenyl, C₂-C₈ alkenyloxy, C₃-C₈ cycloalkyl, C₃-C₈ cycloalkoxy, C₆-C₁₀ aryl, C₆-C₁₀ aryloxy, C₇-C₁₂ arylalkyl, C₇-C₁₂ arylalkoxy, C₇-C₁₂ alkylaryl, or C₇-C₁₂ alkylaryloxy; each n is independently an integer from 0 to 4; x is the mole percentage of the carbonate unit; y has an average value of from about 2 to about 1,000; and z is the mole percentage of the siloxane unit.

18. The composition of claim 17, wherein the ratio of x:z is from about 20 to about 500.

19. The composition of claim 17, wherein A is isopropylidene.

20. The composition of claim 12, wherein the terephthalate polymer has a weight average molecular weight of from about 50,000 to about 110,000.

21. A copolycarbonate composition comprising a blend of a polycarbonate-polydimethylsiloxane (PC—Si) copolymer and a terephthalate polymer;
wherein the PC—Si copolymer is of the general Formula (III): 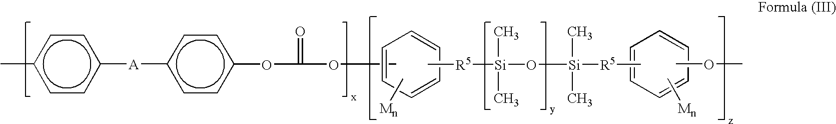
wherein A is isopropylidene; each R⁵ is independently selected from divalent C₂-C₈ aliphatic; each M is independently selected from halogen, cyano, nitro, C₁-C₈ alkylthio, C₁-C₈ alkyl, C₁-C₈ alkoxy, C₂-C₈ alkenyl, C₂-C₈ alkenyloxy, C₃-C₈ cycloalkyl, C₃-C₈ cycloalkoxy, C₆-C₁₀ aryl, C₆-C₁₀ aryloxy, C₇-C₁₂ arylalkyl, C₇-C₁₂ arylalkoxy, C₇-C₁₂ alkylaryl, or C₇-C₁₂ alkylaryloxy; each n is independently an integer from 0 to 4; x is the mole percentage of the carbonate unit; y has an average value of from about 2 to about 1,000; and z is the mole percentage of the siloxane unit;
wherein the terephthalate polymer is of the general Formula (IV): 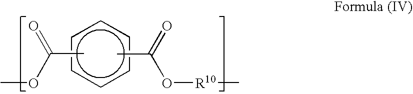
wherein R¹⁰ is a divalent aliphatic or cycloaliphatic radical containing from about 1 to about 10 carbon atoms;
wherein the terephthalate polymer comprises from about 5 to about 20 weight percent of the copolycarbonate composition; and
wherein the composition has a melt volume rate of at least 8 cc/10 min at 300° C./1.2 kg, according to ASTM D1238, and a notched Izod impact strength of at least 11.5 ft-lb/inch at minus 40° C., according to ASTM D256.
